(19) United States
(12) Patent Application Publication
(10) Pub. No.: US 2014/0291449 A1
(43) Pub. Date: Oct. 2, 2014

(54) DEVICE FOR HEATING A PORTION OF A CABIN FLOOR IN AN AIRCRAFT CABIN

(71) Applicant: Diehl Aerospace GmbH, Überlingen (DE)

(72) Inventors: Ronny Knepple, Uberlingen (DE); Bernd Speth, Uberlingen (DE); Trong Tran, Erlangen (DE)

(73) Assignee: DIEHL AEROSPACE GMBH, Überlingen (DE)

(21) Appl. No.: 14/360,119

(22) PCT Filed: Nov. 10, 2012
(86) PCT No.: PCT/EP2012/004684

§ 371 Date: May 22, 2014

(30) Foreign Application Priority Data
Nov. 23, 2011 (DE) 102011119364.6

(51) Int. Cl. B64D 11/04; B64C 1/18; B64D 13/00; H01M 8/04

(52) U.S. Cl. CPC B64D 11/04; H01M 8/04067; B64C 1/18; B64D 13/00
USPC 244/129.1

(57) ABSTRACT

The invention relates to an arrangement for heating a portion of the cabin floor in an aircraft cabin, wherein the cabin floor has an upper side which can be walked on and a lower side opposite the upper side, comprising a fuel cell and, connected or connectable thereto, a removal device with which a fluid heated by waste heat of the fuel cell is removed from the fuel cell and supplied to a cavity which is adjacent to the lower side of the cabin floor or is located in the cabin floor, and therefore the portion of the cabin floor is heated.

The invention relates to a device for heating a portion of a cabin floor in an aircraft cabin.

In passenger aircraft, on-board galleys are usually located in the vicinity of doors. Stowage spaces for escape chutes are generally located below the on-board galleys. The doors and the stowage spaces each form a cold bridge. As a result, the cabin floor, in particular in the region of an on-board galley, is cold during the flight.

It is known from DE 10 2005 054 883 A1 to use the waste heat of a fuel cell for preparing hot beverages. Excess waste heat is removed to the atmosphere via an external cooler.

Furthermore, it is known to electrically heat the stowage spaces of the escape chutes. The energy for this is generated by means of generators which are driven by the main or auxiliary engines. This has the disadvantage that heating elements have to be installed in the vicinity of the escape chutes. The heating elements require complicated wiring. In addition, the fuel consumption of the main or auxiliary engines is increased.

It is the object of the invention to eliminate the disadvantages according to the prior art. The intention in particular is to specify a device with which a portion of a cabin floor of an aircraft cabin can be heated simply and efficiently. In particular the device is intended to be operable independently of the on-board supply system.

This object is achieved by the features of claim 1. Expedient refinements emerge from the features of claims 2 to 16.

According to the invention, a device for heating a portion of the cabin floor in an aircraft cabin comprises a fuel cell and a removal device. The cabin floor has an upper side which can be walked on and a lower side opposite the upper side. A fluid heated by waste heat of the fuel cell is removed from the fuel cell by the removal device and supplied to a cavity which is adjacent to the lower side of the cabin floor or is located in the cabin floor, and therefore the portion of the cabin floor is heated. That portion of the cabin floor which is to be heated can advantageously therefore be heated independently of the on-board supply system. According to the invention, the waste heat occurring during the operation of a fuel cell is supplied by means of the removal device in a targeted manner to that portion of the cabin floor which is to be heated. The proposed heating of the cabin floor portion is particularly efficient.

The fuel cell can be any type of fuel cell, in particular a proton exchange membrane fuel cell (PEM fuel cell). A methanol reformer can be connected upstream of the fuel cell such that methanol can be used as the energy carrier. It is advantageous in this case that explosive hydrogen does not have to be carried in the aircraft in order to operate the fuel cell. Furthermore, the fuel cell can be a high-temperature fuel cell (HT fuel cell) with a low-temperature fuel cell (LT fuel cell) connected upstream thereof. This produces a cascaded system in which the exhaust air of the LT fuel cell can be used as intake air for the HT fuel cell. It is also conceivable for at least one further HT fuel cell and/or at least one LT fuel cell to be connected upstream of an HT fuel cell.

The portion of the cabin floor can be the floor of an on-board galley. The working conditions for the flight attendants can therefore be improved.

The fuel cell can be supported on the portion of the cabin floor. In this case, the removal device can be configured particularly compactly.

The fluid can be air. Air is safe and is available in the aircraft cabin.

The cavity can be formed by at least one duct integrated in the cabin floor. The duct can branch downstream of the removal device into a plurality of ducts. In particular, the ducts can run parallel to one another. The duct can also be of meandering design. The duct here can be formed in particular by at least one hose.

The cavity can be formed by an escape chute stowage space adjacent to the lower side of the cabin floor. Air heated, for example, by the waste heat of the fuel cell can be introduced into the escape chute stowage space. The escape chutes can therefore be kept above a minimum temperature required for fault-free operation. At suitable heat conductivity and heat capacity, the cabin floor can be configured in such a manner that the heated air introduced into the escape chute stowage space at the same time brings about heating of the cabin floor adjacent to the escape chute stowage space. However, it is also possible directly to heat both the cavity in the escape chute stowage space and the ducts integrated in the cabin floor. For this purpose, part of the air heated by the waste heat of the fuel cell can be introduced into ducts integrated in the cabin floor while another part is introduced into the escape chute stowage space. However, it is also possible that air heated by the waste heat of the fuel cell is first of all introduced into ducts integrated in the cabin floor, said air emerging on the lower side of the cabin floor and from there entering the escape chute stowage space and heating the latter.

The fuel cell can be accommodated in a conventionally sized trolley which is accommodated exchangeably in an insertion section provided therefor in the on-board galley. A trolley of this type can be exchanged rapidly and simply for another trolley.

At least one tank can be located in the same trolley as the fuel cell. The tank can be provided for fuels, such as, for example, ethanol, methanol, hydrogen or for oxygen. However, it is also conceivable for the fuel cell and at least one tank to be located in two different trolleys which can be connected to each other by a fuel line.

A trolley with an empty tank or with a fuel cell requiring servicing can be exchanged by another trolley with a full tank or with a serviced fuel cell. The filling of the tank and the servicing of the fuel cell requiring servicing can be undertaken outside the aircraft. Refueling and servicing therefore do not need to take place while the aircraft is at an airport. Furthermore, the servicing intervals of the permanently installed cabin technology do not need to be taken into consideration.

The removal device can have a first portion and a second portion. The first portion can be fixedly connected to the fuel cell. The second portion can be fixedly connected to the cabin floor. The removal device can furthermore have a coupling for the releasable connection of the first portion and of the second portion. By means of the coupling, the first portion and the second portion can be connected to each other. In particular, the coupling can automatically connect the fuel cell to the second portion of the removal device while the trolley accommodating the fuel cell is being latched into a holding position. This facilitates the handling.

The removal device can be provided with a fan for conveying the fluid. It can therefore be ensured that the fluid is transported continuously from the fuel cell to the cavity.

The removal device can have a hot air duct for removing the air heated by the waste heat of the fuel cell to a first kitchen appliance and a warm air duct for conducting the heated air from the first kitchen appliance to the cavity. The removal device can furthermore have a first line for removing the heated air from the first kitchen appliance to a second kitchen appliance. The removal device can have at least one further line for conducting the heated air in each case from a preceding kitchen appliance to a further kitchen appliance. The kitchen appliances in the on-board galley sometimes have different operating temperatures. The kitchen appliances are advantageously therefore supplied with heated air in a descending sequence of their operating temperatures. Kitchen appliances can be hybrids which can obtain their energy from a plurality of sources, in particular from electrical and thermal energy. The intelligent use of the waste heat permits high energy efficiency for the use of a fuel cell in the on-board galley of an aircraft.

An intake pipe can be provided for supplying the fuel cell with cabin air. However, it is also possible for the air which has flowed through the kitchen appliances and/or the cavity to be made available again to the fuel cell. An at least substantially closed circuit can be formed in this manner.

Refinements of the invention are explained in more detail below with reference to the drawings, in which:

FIG. 1 shows a schematic illustration of a partial section of a device according to the invention,

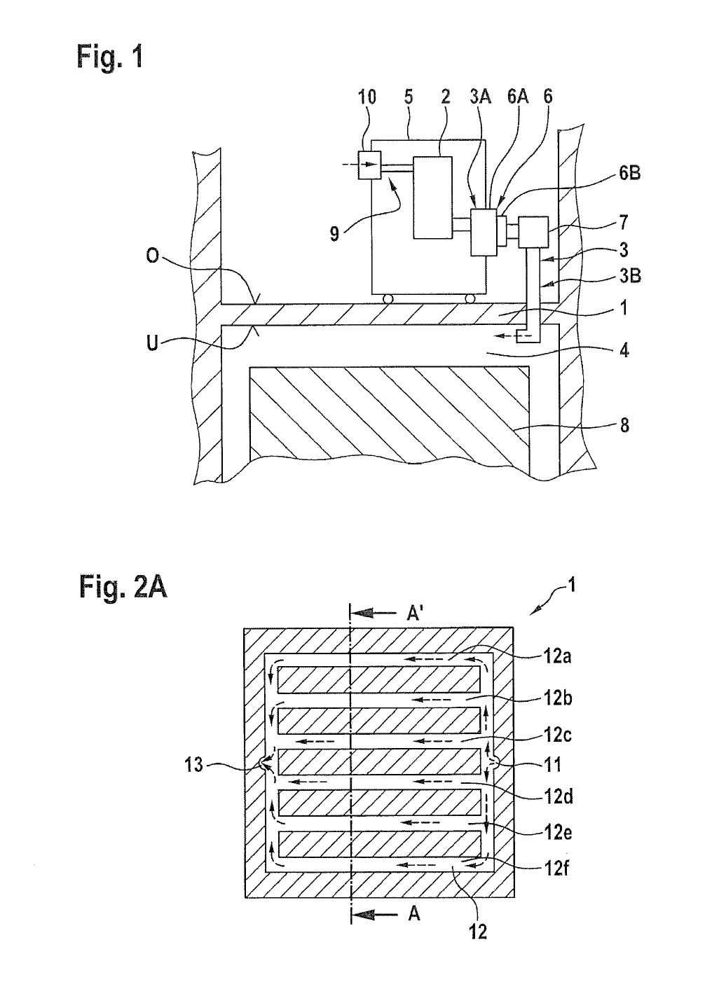

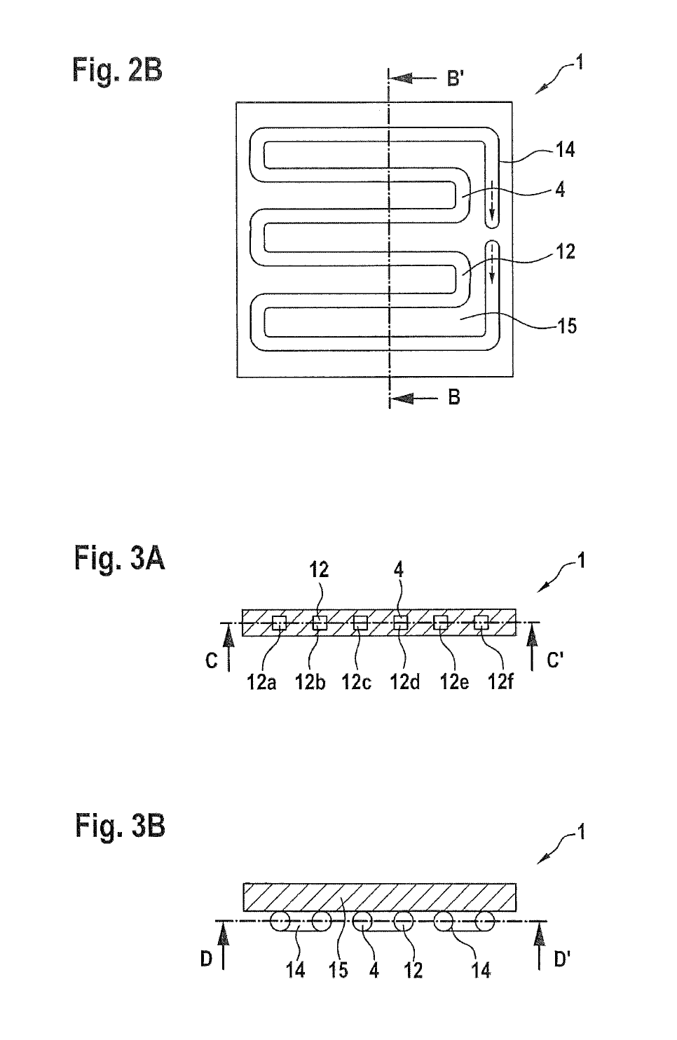

FIG. 2A shows a schematic illustration of a longitudinal section of a portion according to the invention of the cabin floor according to C-C′ in FIG. 3A,

FIG. 2B shows a schematic illustration of a longitudinal section of a portion according to the invention of the cabin floor according to D-D′ in FIG. 3B,

FIG. 3A shows a schematic illustration of a cross section of a portion according to the invention of the cabin floor according to A-A′ in FIG. 2A,

FIG. 3B shows a schematic illustration of a cross section of a portion according to the invention of the cabin floor according to B-B′ in FIG. 2B, and

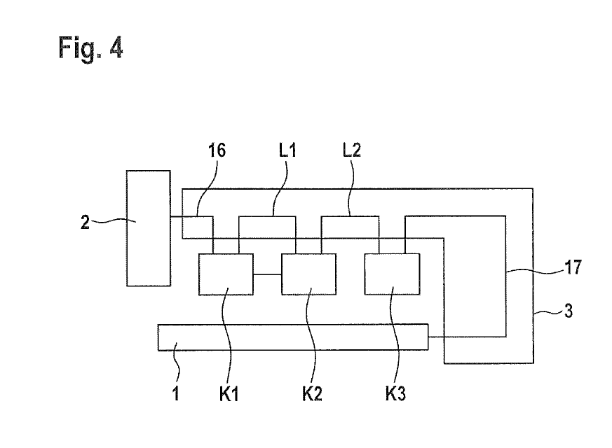

FIG. 4 shows a flow diagram for illustrating the supply of kitchen appliances with heated air.

FIG. 1 schematically shows an arrangement according to the invention for heating a portion of the cabin floor 1 in an aircraft cabin. The cabin floor 1 has an upper side O which can be walked on and a lower side U opposite the upper side O. The arrangement according to the invention comprises a fuel cell 2 and a removal device 3 with a first portion 3A and a second portion 3B. The first portion 3A is fixedly connected to the fuel cell 2 and the second portion 3B is fixedly connected to the cabin floor 1. The first portion 3A has a first coupling part 6A and the second portion 3B has a second coupling part 6B. The first coupling part 6A and the second coupling part 6B form a coupling 6 which releasably connects the first portion 3A and the second portion 3B.

The fuel cell 2 and the first portion 3A are accommodated in a trolley 5. The trolley 5 has the same external dimensions as an on-board galley trolley which is used in an aircraft for accommodating meals, beverages, garbage, etc. The first coupling part 6A is arranged in the region of any part of an outer panel of the trolley 5, in particular on a rear side of the trolley 5. The first coupling part 6A can also be provided on a right or left side of the trolley 5 or on a lower side or upper side of the trolley 5. The first coupling part 6A can be configured in particular in such a manner that it does not protrude out of the outer panel of the trolley 5. The trolley 5 is accommodated in an exchangeable manner in an insertion section provided therefor in the on-board galley. The second portion 3B of the removal device 3 together with the second coupling part 6B is located in a permanently installed manner in the insertion section of the on-board galley.

In the refinement according to FIG. 1, the trolley 5 furthermore has a supply device 9 for supplying cabin air to the fuel cell 2. The first end of the supply device 9 has an intake pipe 10. The supply device 9 is fixedly connected at the second end thereof to the fuel cell 2.

The removal device 3 is provided with a fan 7 for conveying hot exhaust air from the fuel cell 2 into a cavity 4. In the refinement according to FIG. 1, the cavity 4 is adjacent to the lower side U of that portion of the cabin floor 1 which is to be heated. In addition, an escape chute 8 is accommodated in the cavity 4.

However, the cavity 4 can also be located in the cabin floor 1. FIG. 2A shows a schematic illustration of a longitudinal section of a portion according to the invention of the cabin floor 1. The cavity 4 here is formed by ducts 12a, 12b, 12c, 12d, 12e, 12f integrated in the cabin floor 1. For this purpose, the cabin floor 1 has a duct inlet 11 which is connected to the second portion 3B of the removal device 3. A duct 12 emerges from the duct inlet 11. The duct 12 branches into individual ducts 12a, 12b, 12c, 12d, 12e, 12f. The individual ducts 12a, 12b, 12c, 12d, 12e, 12f lead into a duct outlet 13.

FIG. 2B shows a schematic illustration of a longitudinal section of a further portion according to the invention of the cabin floor 1. In this exemplary embodiment, the duct 12 is of meandering design. For this purpose, the cabin floor 1 can comprise a hose 14 and a floor structure 15. The hose 14 can be fastened to the lower side of the floor structure 15. However, the hose 14 can alternatively also run in the interior of the cabin floor 1.

FIG. 3A shows a schematic illustration of a cross section of a portion according to the invention of the cabin floor 1 according to A-A′ in FIG. 2A. Individual ducts 12a, 12b, 12c, 12d, 12e, 12f which are connected to one another and form the cavity 4 are integrated in the cabin floor 1. FIG. 3B shows a schematic illustration of a cross section of a portion according to the invention of the cabin floor 1 according to B-B′ in FIG. 2B. The cabin floor 1 here comprises a hose 14 and a floor structure 15. The hose 14 here is fastened to the lower side of the floor structure 15.

FIG. 4 shows the route of the heated air in the form of a flow diagram. Kitchen appliances K1, K2, K3 used in the on-board galley can be hybrid appliances which can be supplied both with electrical energy and with thermal energy. The air heated by the waste heat of the fuel cell 2 can therefore also be used for supplying kitchen appliances. According to FIG. 4, the removal device 3 at least substantially comprises a hot air line 16, a first line L1, a second line L2 and a warm air line 17.

The operation of the arrangement according to the invention is explained in more detail below. With the removal device 3, air heated by waste heat of the fuel cell 2 is removed from the fuel cell 2 with the aid of the fan 7 and supplied to a cavity 4 which is adjacent to the lower side U of the cabin floor 1 or is located in the cabin floor 1. The air supplied to the cavity 4 outputs its heat to the portion of the cabin floor 1. The cabin floor 1 stores the heat and conducts the latter to the upper side O thereof. For this purpose, the cabin floor 1 contains components having a high heat capacity and components having high heat conductivity. For this purpose, the cabin floor 1 can have a structure in the form of aluminum. Aluminum has a high heat capacity and readily conducts heat.

The fan 7 sucks up the air heated by the fuel cell 2 and blows said air into the cavity 4 via a further line provided in the second portion 3B of the removal device 3.

Cabin air can be sucked up by the intake pipe 10 in order to supply the fuel cell 2. Furthermore, it is also possible to configure the supply device 9 in such a manner that the air conducted into the cavity 4 by the removal device 3, after passing through the cavity 4, is extracted again from the cavity 4 and recycled for supplying the fuel cell 2. An air circuit can thus be provided. A closed air circuit is conceivable here. However, cabin air or oxygen accommodated in a tank can additionally also be supplied to the air circuit.

The servicing of the fuel cell 2 and the topping up of the fuel of a tank (not illustrated) provided in the trolley 5 take place after the trolley 5 is removed from the aircraft. When the trolley 5 is pushed in, the first coupling part 6A automatically latches into the second coupling part 6B provided in the insertion section. The separating of the first coupling part 6A from the second coupling part 6B in order to remove the trolley 5 from the insertion section can also take place automatically.

According to FIGS. 2A, 2B, 3A and 3B, ducts 12a, 12b, 12c, 12d, 12e, 12f or a hose 14 can form the cavity 4. The air heated by the fuel cell 2 is then introduced by the removal device 3 according to FIG. 2A into the duct inlet 11 and distributed via the individual ducts 12a, 12b, 12c, 12d, 12e, 12f. Alternatively, the air is introduced according to FIG. 2B into the hose 14 and runs through the hose 14. During passage through the ducts 12a, 12b, 12c, 12d, 12e, 12f or the hose 14, the air outputs heat to the cabin floor 1.

The ducts 12a, 12b, 12c, 12d, 12e, 12f and/or the hose 14 can communicate with an escape chute stowage space adjacent to the lower side U of the cabin floor and therefore the interior of said ducts or hose and the escape chute stowage space form the cavity 4 and, after passage through the ducts 12a, 12b, 12c, 12d, 12e, 12f and/or through the hose 14, the air flows into the escape chute stowage space. After passage through the ducts 12a, 12b, 12c, 12d, 12e, 12f and/or through the hose 14 or after flowing through the escape chute stowage space, the air can be conducted into a supply device 9 which supplies the air to the fuel cell 2 again or can be discharged to the cabin air.

The operation of the removal device 3 is described below according to FIG. 4. The air heated by the waste heat of the fuel cell 2 passes through the hot air line 16 into a first kitchen appliance K1, from the first kitchen appliance K1 through the first line L1 to a second kitchen appliance K2, from the second kitchen appliance K2 through the second line L2 to a third kitchen appliance K3 and finally through the warm air line 17 to the cabin floor 1. The heated air here in each case outputs heat, and therefore is successively cooled. The kitchen appliances can be, for example, an oven, a hot water boiler, etc. The kitchen appliances generally have different operating temperatures. It is therefore advantageous to select the sequence of the kitchen appliances in such a manner that the operating temperature of a kitchen appliance supplied later does not exceed the operating temperature of a kitchen appliance supplied previously. In the refinement illustrated, the first kitchen appliance K1 has the highest operating temperature, the second kitchen appliance K2 has the second highest operating temperature and the third kitchen appliance K3 has the third highest operating temperature.

Further advantages of the arrangement according to the invention are described below. Since the cabin floor 1 can store heat, the temperature on the upper side O of that portion of the cabin floor 1 which is to be heated is independent of the respectively current heat generation of the fuel cell 2. Therefore, customary fluctuations in the heat generation of the fuel cell 2 do not have any noticeable effect on the temperature on the upper side O of that portion of the cabin floor 1 which is to be heated.

By heating the escape chute stowage space, it is possible to prevent the escape chute 8 from being exposed to relatively great temperature fluctuations. As a result, the emergency chute 8 remains flexible and is durable for a longer time.

The handling of the fuel cell 2 by accommodation in a trolley 5 is particularly simple.

### LIST OF DESIGNATIONS

1 Cabin floor
2 Fuel cell
3 Removal device
3A First portion
3B Second portion
4 Cavity
5 Trolley
6 Coupling
6A First coupling part
6B Second coupling part
7 Fan
8 Escape chute
9 Supply device
10 Intake pipe
11 Duct inlet
12 Duct
12a-f Ducts
13 Duct outlet
14 Hose
15 Floor structure
16 Hot air duct
17 Warm air duct
K1 First kitchen appliance
K2 Second kitchen appliance
K3 Third kitchen appliance
L1 First line
L2 Second line
O Upper side
U Lower side

1. An arrangement for heating a portion of the cabin floor in an aircraft cabin, wherein the cabin floor has an upper side which can be walked on and a lower side opposite the upper side, comprising a fuel cell and, connected or connectable thereto, a removal device with which a fluid heated by waste heat of the fuel cell is removed from the fuel cell and supplied to a cavity which is adjacent to the lower side of the cabin floor or is located in the cabin floor, and therefore the portion of the cabin floor is heated.

2. The arrangement as claimed in claim 1, wherein the portion of the cabin floor forms the floor of an on-board galley.

3. The arrangement as claimed in claim 1, wherein the fuel cell is supported on the portion of the cabin floor.

4. The arrangement as claimed in claim 1, wherein the fluid is air.

5. The arrangement as claimed in claim 1, wherein the cavity is formed by at least one duct integrated in the cabin floor.

6. The arrangement as claimed in claim 5, wherein the duct is of meandering design.

7. The arrangement as claimed in claim 1, wherein the cavity is formed by an escape chute stowage space adjacent to the lower side of the cabin floor.

8. The arrangement as claimed in claim 1, wherein the fuel cell is accommodated in a conventionally sized trolley which is accommodated exchangeably in an insertion section provided for this purpose in the on-board galley.

9. The arrangement as claimed in claim 1, wherein the removal device has a first portion and a second portion.

10. The arrangement as claimed in claim 9, wherein the first portion is fixedly connected to the fuel cell and the second portion is fixedly connected to the cabin floor.

11. The arrangement as claimed in claim 9, wherein the removal device has a coupling for the releasable connection of the first portion to the second portion.

12. The arrangement as claimed in claim 1, wherein the removal device is provided with a fan for conveying the fluid.

13. The arrangement as claimed in claim 1, wherein the removal device has a hot air duct for removing the air heated by the waste heat of the fuel cell to a first kitchen appliance and a warm air duct for conducting the heated air from the first kitchen appliance to the cavity.

14. The arrangement as claimed claim 13, wherein the removal device has a first line for removing the heated air from the first kitchen appliance to a second kitchen appliance.

15. The arrangement as claimed in claim 14, wherein the removal device has at least one further line for conducting the heated air in each case from a preceding kitchen appliance to a further kitchen appliance.

16. The arrangement as claimed in claim 1, wherein an intake pipe is provided for supplying the fuel cell with cabin air.
